(19) United States
(12) Patent Application Publication
(10) Pub. No.: US 2007/0226006 A1
(43) Pub. Date: Sep. 27, 2007

(54) Determining expected cost for a medical visit

(75) Inventors: Richard Ruscio, Spencerport, NY (US); John R. Squilla, Rochester, NY (US); Donna K. Rankin-Parobek, Honeoye Falls, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/387,491

(22) Filed: Mar. 23, 2006

(51) Int. Cl. G06Q 10/00

(52) U.S. Cl. 705/2

(57) ABSTRACT

A method for automatically determining the expected cost for a medical visit includes entering patient identification information (30); accessing the patient's medical records; entering a reason for the patient's visit (35), identifying the patient's health-care plan (50); and calculating an expected cost and payment for the medical visit.

### FIELD OF THE INVENTION

This invention relates in general to medical information systems, and in particular to systems for clinics and doctor's offices.

### BACKGROUND OF THE INVENTION

In a doctor's office or a medical clinic, there is a need to gather patient information or update the information periodically. It is also desirable to obtain information on the method of payment that the patient will use. Often, presenting a card identifying the patient's insurer does this. Less often, the insurer is called to confirm the coverage.

The patient knows what his or her medical symptoms are but is less sure of costs related to curing his or her condition. The course of treatment is up to the doctor, but there is a need, from the patient's perspective, to understand what will be covered by insurance and what will be paid for out-of-pocket. Recent changes in insurance coverage and legislative modifications make this more and more difficult for the patient to make properly informed decisions. For those who have no medical coverage, the information on costs may by even more important.

Informational kiosks exist today (www.galvanon.com) that collect patient information at a hospital, clinic or office. These systems may link this information with practice management software (PMS) and electronic medical records (EMR). The insurers, like Blue Cross/Blue Shield, also have systems that allow doctor's to access their system for information about their patients, with the patient's permission. An example is shown in the following URL: (https://www.excellusbcbs.com/providers/index.shtml). Methods for identify checking of a patient are also well known in the art and include methods such as records with bar codes, multiple question/answer sequences, user name/password pairs, patient ID bracelets, RFID tags placed on the patient, etc.

There is an unmet need, however, to provide doctors and patients with a quick, automated, estimate of financial information—patient cost, provider payment, concerning a patient visit or procedure. This estimate may be based on a variety of information on different servers or websites.

### SUMMARY OF THE INVENTION

Briefly, according to one aspect of the present invention a method for automatically determining the expected cost for a medical visit comprises: entering patient identification information; accessing the patient's medical records; entering a reason for the patient's visit, identifying the patient's health-care plan; and calculating an expected cost and payment for the medical visit.

The present invention is intended to provide the patient with a first and last contact point for a visit to a primary care physician (PCP) office or clinic. In addition, the invention estimates the payment that will be required as a result of this visit, relative to their coverage and out-of-pocket expenses.

The present invention is intended to be easily adaptable to the office/clinic where it is used, without requiring the intervention of highly trained and experienced staff for extended periods of time, by integrating with the existing PMS in the office or clinic.

### BRIEF DESCRIPTION OF THE DRAWINGS

FIG. 1 is a flow diagram of the process the patient goes through in the office/clinic.

FIG. 2 is a representation of the patient demographic information, available to the office/clinic.

FIG. 3a is a representation of the billing and privacy statement.

FIG. 3b is a representation of a Health Insurance Portability and Accountability Act (HIPAA) privacy statement.

FIG. 4 is a flow chart, describing the validation of a patient's coverage by a health care payer.

FIG. 5 is a flow chart, showing possible billing relationships between the office/clinic and health care payers.

FIG. 6 is a flow chart, showing the patient process for creating and updating paper based medical records.

FIG. 7 is a flow chart, showing the patient process for creating and updating electronic medical records.

FIG. 8 is a flow chart, showing the process for estimating a charge set.

FIG. 9 is a representation of a billing summary available at patient check-out.

### DETAILED DESCRIPTION OF THE INVENTION

The present invention will be directed in particular to a system for entering, modifying, and interpreting information from several sources to optimize business elements of a doctor's office of clinical check-in/check-out system. It is to be understood that elements not specifically shown or described may take various forms well known to those skilled in the art.

The system is intended to provide the patient with a first and last contact point for a visit to a PCP office or clinic. At check-in, the patient interacts with the system to establish identity, update/validate insurance information, patient demographic information, medical history, and purpose of visit. At this point, the system estimates the payment that the patient will be required to make.

The system is intended to be easily adaptable to the office/clinic where it is used, without requiring the intervention of highly trained and experienced staff for extended periods of time. Integration with any PMS is accomplished by means of creating a standard interface specifying a standard interface to the PMS, and creating custom code as required to access the PMS.

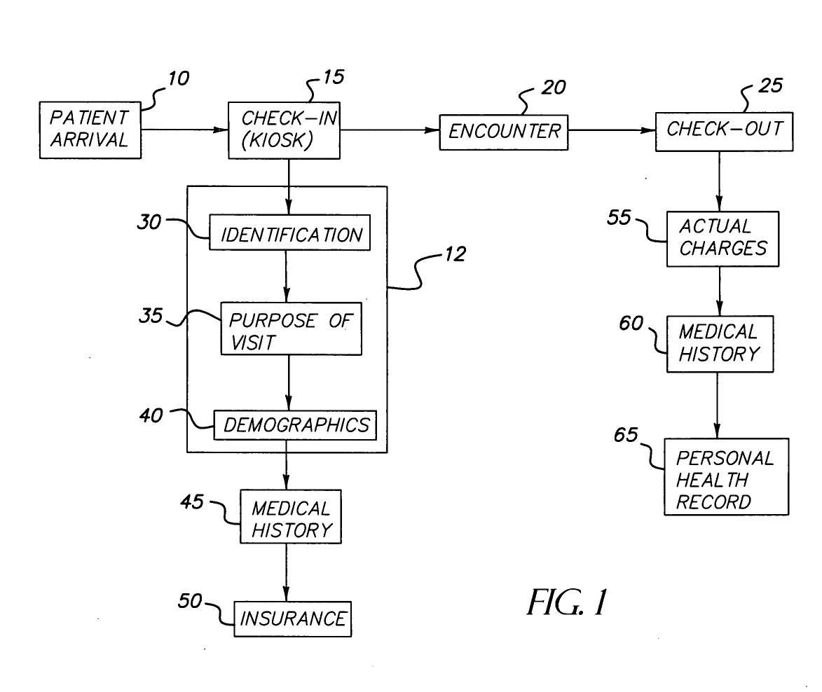

Referring now to FIG. 1, a flow diagram of the process the patient goes through in the office/clinic:

Patient identity establishment, at patient arrival 10, is the responsibility of the office/clinic. The check-in (kiosk) 15 assists in this identification 30 by allowing for the use of bar coded or magnetic stripe card or smart card media (or more, jump drive, web links, eye scan, etc.), to be created and/or supplied by the office/clinic, and used as an access control mechanism to the system. Examples are well known in the industry: (http://www.freescale.com/webapp/sps/site/application.jsp?nodeId=02430ZnQXG XDWd).

In addition to the information from those media, additional data entry and verification is required to establish reasonable identification (e.g. patient date of birth). Once the system accepts the verification sequence, the patient is allowed further into the system workflow process. Identity checks, as appropriate, are maintained throughout the balance of the flow. These are required because the patient, and so the check-in system, may access multiple different computer systems for relevant information, depending on the office/clinic computer system configuration and service provision.

Within the scope of the office/clinic, there is demographic information associated with the patient, including but not limited to, home address, phone number and other contact information. The demographic information is retained in the office/clinic PMS 12. That demographic information is subject to change from time to time.

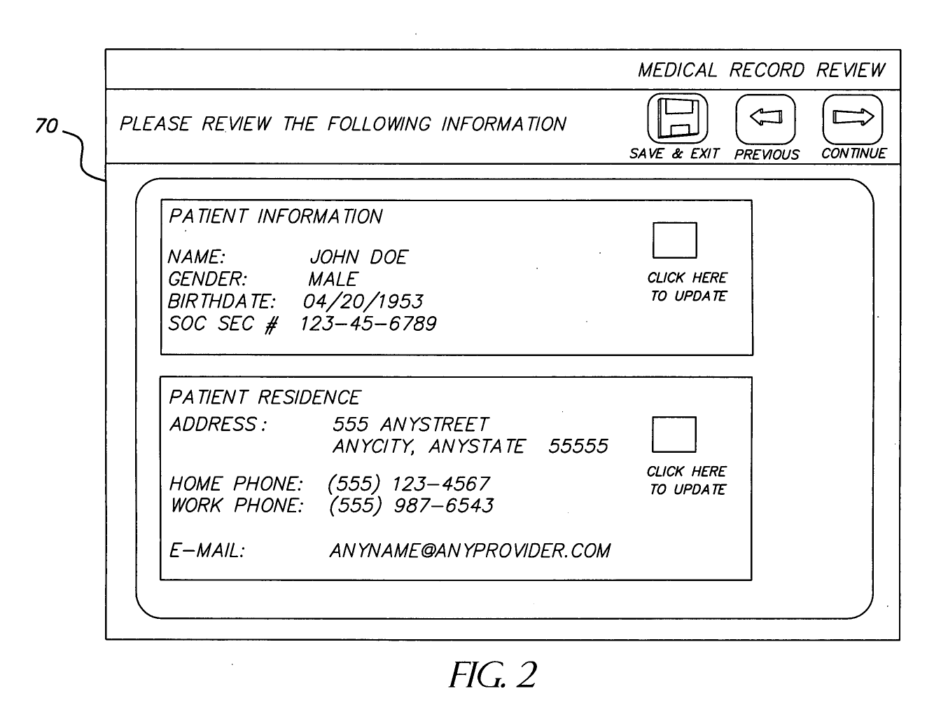

Referring to FIG. 2, the system provides the patient with the opportunity to review and update that demographic 40, by retrieving it from the PMS, providing a data entry/edit user interface 70, and placing it back into the office/clinic PMS. Methods to automatically assist in this data placement are well known. An example can be found at www.Google.com where auto fill can be used in web-based applications.

Generally, prior to the start of this process, the patient has made an appointment at the office/clinic, usually thru the office/clinic staff, providing some purpose of the visit 35. Should the appointment not have been made, or the reason not been recorded, the system responds appropriately by proceeding thru the sequence of questions/answers to create the appointment, and inquire as to the purpose of the visit.

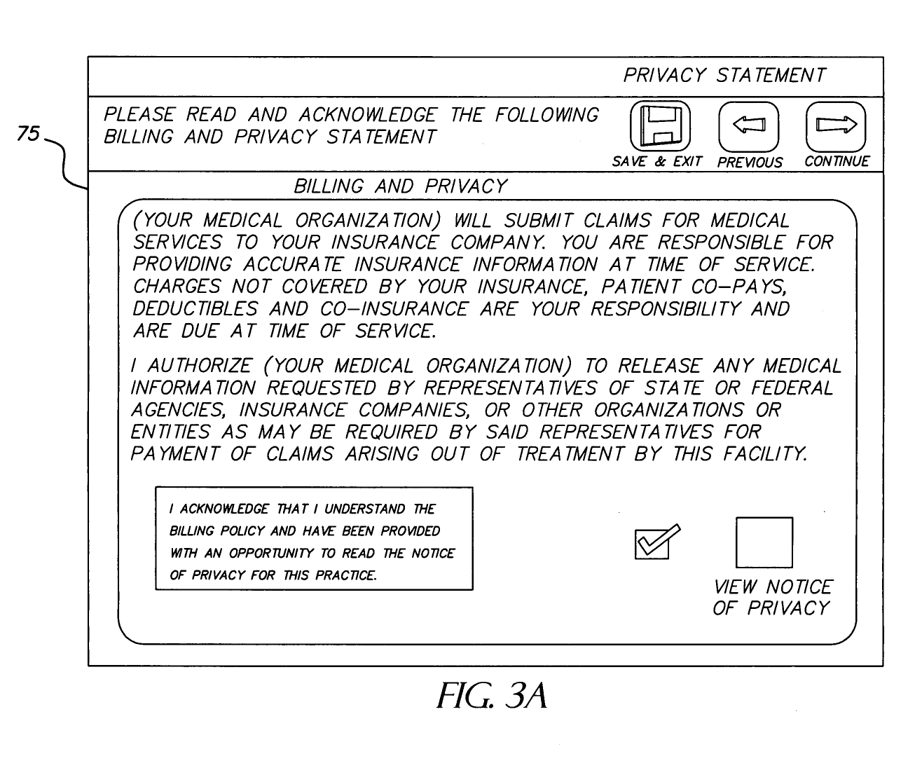

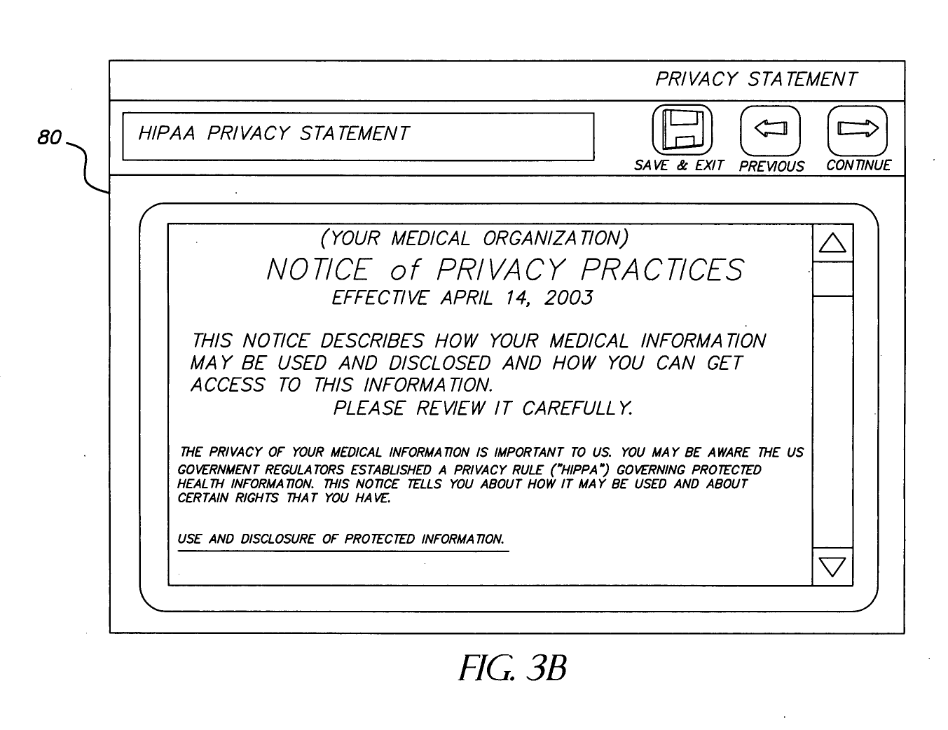

Referring to FIG. 3a, billing and privacy 75 agreements are presented to the patient. The patient is given the opportunity to read and acknowledge the terms and conditions.

Referring to FIG. 3b, HIPAA Compliance for privacy practices 80 is provided through the system, by means of an interface allowing for an electronic signature and screens 70 requesting appropriate allowances.

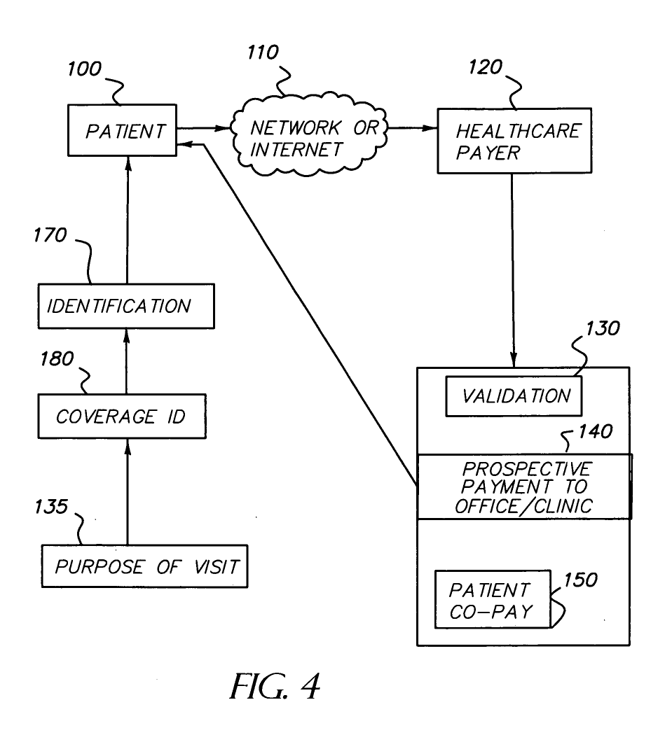

The system requires the patient to validate appropriate services rendered payment capability, usually through health care insurance 50 coverage and an on-site co-pay. Referring to FIG. 4, this is accomplished by having the patient 100 identify 170 his/herself to the appropriate health care payer organization, and specify the patient coverage identifier 180 with the health care payer 120. The same mechanisms as used for patient identification can be used here, to establish identity to the health care payer organization, as well as to specify contract/coverage information. Identity validation 140 may be different from that used initially, because there is no possibility of getting all cooperating/health care paying systems to presume the same patient validation method.

The patient information is communicated to the health care payer 120 via computer systems connected by a network or Internet 110 connection.

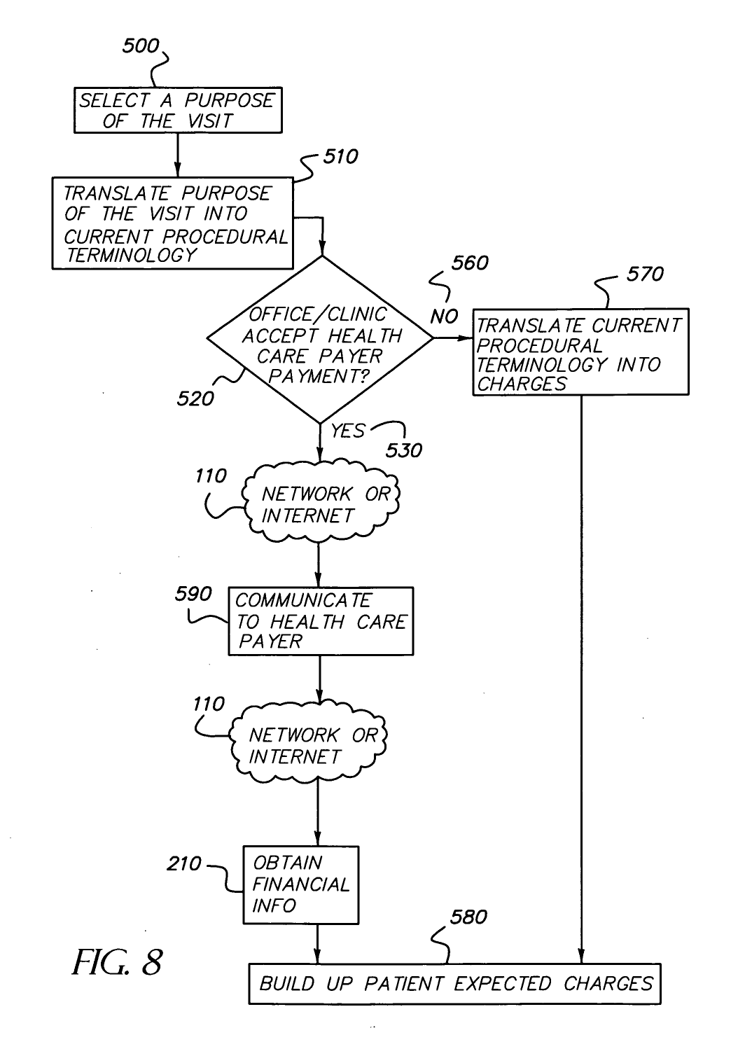

Referring to FIG. 8, the purpose of the visit 500 corresponds to one or more procedures to be performed, which in turn correspond to one or more current procedure terminology (CPT) codes 510. The CPT codes are shorthand for a sequence of medical procedures, and as such, represent billable ‘units’ to health care payers. In actual practice, prices for medical procedures are loosely based, in the United States, on Medicare published rates. Health care payers base their re-imbursement rates on differences from Medicare rates. Each health care payer has the possibility of having different rates. Additionally, as health care payers offer coverage contracts to health care buyers (either to group buyers (e.g. employers), or individual consumers), those coverage contracts may have different characteristics. Examples of differences among coverage plans include co-pay and reimbursement amounts, payment limit caps, and alternative forms of patient payments.

Those codes are translatable into financial characteristics, specific to health care payers and their contracts/coverages, including but not limited to: patient co-pay 150, prospective payment to office/clinic 140 to office/clinic, and any constraints on reimbursement.

One purpose of the system is to provide the patient with information regarding the expected cost to the patient of the upcoming procedures, and to provide the office/clinic staff with information regarding the patient payment mechanism.

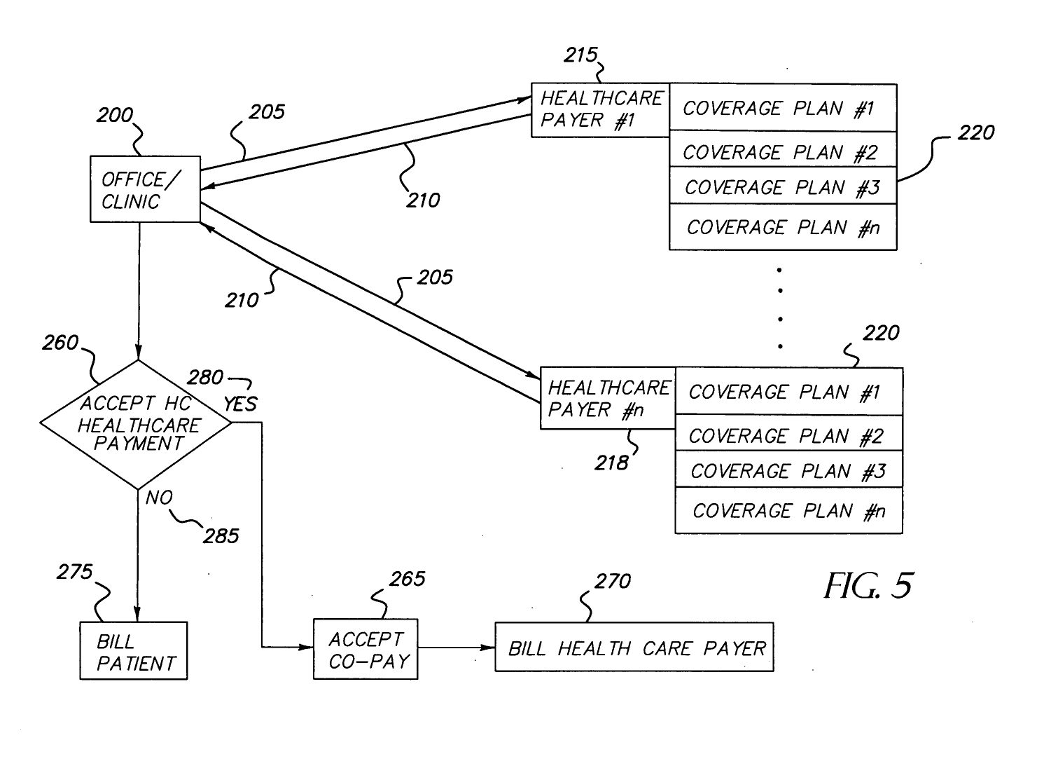

The office/clinic 200 will generally, but not always, have billing relationships with more than one health care payer 215, 218, each of which will offer one or more coverage plans 220. This relationship is shown in FIG. 5. After determining the appropriate health care payer, the computer system in the office/clinic will communicate with the health care payer 590, sending 205 the patient identification, coverage ID and purpose of visit, in the manner the health care payer system expects, which yields returning information 210 concerning patient co-pay, prospective payment to office/clinic, and any constraints on reimbursement.

The office/clinic will make the decision to accept the health care payer payment 520. In the case where the office/clinic will bill the health care payer 280, 530, the office/clinic will accept the co-pay 265 from the patient, and subsequently bill the health care payer 270.

Some offices/clinics may refuse to bill health care payers 525, not accept health care payer payment 260, and require direct patient payment 285. The office/clinic will have a pricing list that details the charges to be made for the CPT codes that correspond to the visit. The system will use that pricing list to translate CPT codes to charges 570 for the visit. In this case, the office/clinic will bill the patient 275 the amount due. Information about health care payer coverage is still of value to the practice, for the purposes of: establishing an understanding of community pricing levels; determining areas where premium pricing over community levels may be justified; demonstrating the economic viability of the office/clinic to external parties. It is of course possible that offices/clinics that do not have billing/paying relationships with specific health care payers will not be allowed access to that specific information.

Regardless of the sources of information, there is sufficient data present to build up patient expected charges 580, and present the expected costs of the visit.

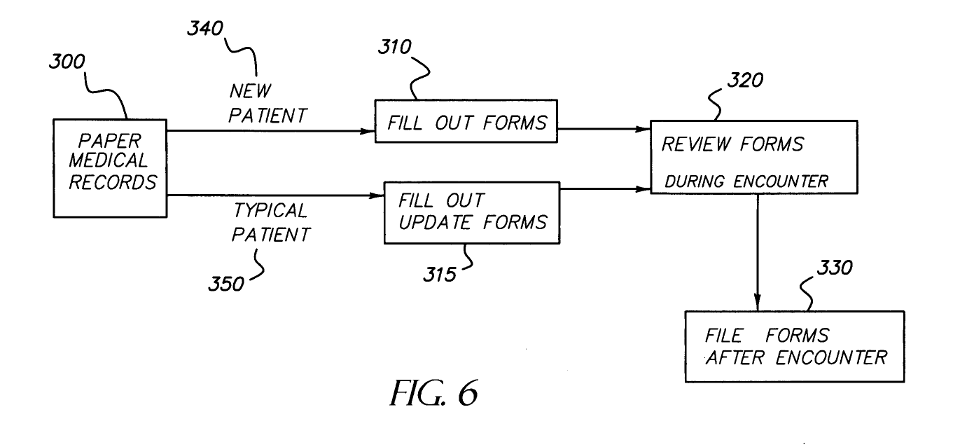

Referring to FIG. 6, many offices/clinics maintain paper medical records (MR) 300 for their patients. New patients 340 will be required to fill out forms 310 on paper. The typical patient 350 will be asked to review printed, existing information, and fill out update forms 315. In either case, the new or updated paper forms will be reviewed during the encounter with medical personnel 320. After the encounter, the forms will be placed into a paper file (‘the chart’) 330.

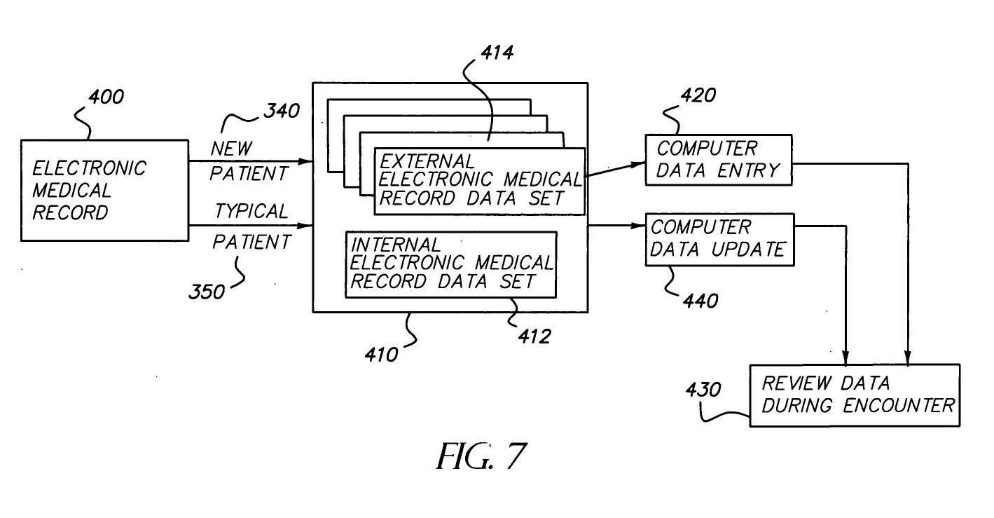

Referring to FIG. 7, some offices/clinics maintain electronic medical records (EMR) 45, 400 for each patient, using local systems 412, remote systems 414, or a hybrid of both 410. Over time, more remote EMR systems will be in use, allowing the system to provide increasing utility to the patient. New patients 340 will be required to populate their EMR via computer data entry 420, while the typical patient 350 will review existing information, and perform a computer data update 440. The system provides the typical patient with a view of the current EMR, for the purposes of review/validation, as well as thought provocation prior to the procedure. Review/validation is useful for patients with multiple offices/clinics to visit, as well as providing reminders for office/clinic staff interactions. There will be a review of the data during the encounter 430. During or after the encounter, the medical staff will update the information in the EMR as appropriate.

After check-in, the patient proceeds with the encounter 20, and participates in the procedures/tests/purposes of the visit. There is always the possibility that the initially provided visit reason does not describe the actual encounter, or additional procedures were performed, or other non-anticipated activity took place, which will impact the cost to the patient and/or payments to the office/clinic. The staff of the office/clinic must assure that the system has access to the actual procedures which took place, in order to assure that cost and billing information is available to the patient prior to leaving the office/clinic.

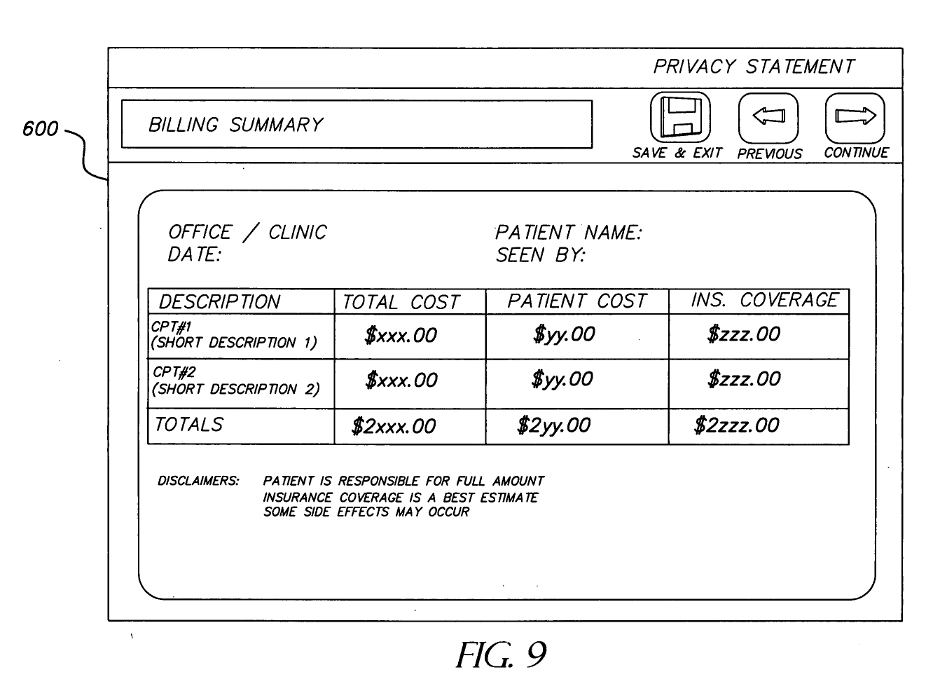

At check-out 25, the patients is enabled to view the actual charges 55 relevant to the visit 600, shown in FIG. 9, review any current or new information in their medical history 60, and create a personal health record (PHR) 65 for their personal use.

The invention has been described in detail with particular reference to certain preferred embodiments thereof, but it will be understood that variations and modifications can be effected within the scope of the invention.

### PARTS LIST

10 patient arrival at doctor's office
12 practice management system (PMS)
15 check in at kiosk
20 encounter with doctor
25 check-out from office
30 patient identification
35 purpose of patient visit
40 patient demographics
45 patient medical history
50 patient insurance
55 actual charges for visit
60 medical history update
65 personal health record
70 sample patient demographics screen
75 sample billing and privacy screen
80 sample HIPAA notice of privacy practices screen
100 patient
110 network or Internet
120 healthcare payer
130 validation from healthcare payer
140 healthcare payer payment to office/clinic
150 patient co-pay
170 patient identification
180 patient coverage ID
200 office/clinic
205 patient identification, coverage ID and current procedural terminology (CPT)
210 payment information from healthcare provider
215 healthcare payer #1
218 healthcare payer #n
220 coverage plan 1, 2, 3, n
260 choice on acceptance of healthcare payment
265 acceptance of co-pay
270 billing of healthcare payer
275 bill payment by patient
280 healthcare coverage is accepted
285 healthcare coverage is refused
300 paper medical record (MR)
310 fill out paper forms
315 fill out update paper forms
320 review of paper forms during visit
330 file paper forms after visit
340 new patient
350 typical patient
400 electronic medical record (EMR)
410 EMR data sets
412 internal EMR data set
414 external EMR data sets
420 computer data entry
430 review of data during visit
440 computer data updates
500 select a purpose of the visit
510 translate purpose of the visit into CPT(s)
520 office/clinic accept health care payer payment
530 yes, accept HCP payment
560 no, do not accept HCP payment
570 translate CPT(s) into charges
580 build up patient expected charges
590 communicate to health care payer
600 screen representation billing summary

1. A method for automatically determining the expected cost for a medical visit comprising:
entering patient identification information;
accessing said patient's medical record;
entering a reason for said patient's visit;
identifying said patient's health-care plan; and
calculating an expected cost for said medical visit.

2. A method as in claim 1 wherein said expected cost is an amount to be paid by said patient.

3. A method as in claim 1 wherein said expected cost is an amount to be paid by said health-care plan to a medical services provider.

4. A method as in claim 1 comprising the additional step of:
verifying said patient's identification information.

5. A method as in claim 1 comprising the additional step of:
verifying said patient is enrolled in said health-care plan.

6. A method as in claim 1 comprising the additional step of:
updating said patient's medical record.

7. A method as in claim 1 comprising the additional step of:
updating said patient's medical record.

8. A method as in claim 1 wherein said patient's preferred pharmacy is in said patient's medical record.

9. A system for estimating a cost for a medical visit comprising:
entering patient identification information on a local or remote server;
accessing said patient's medical record on a local, remote, or web server;
entering a reason for said patient's visit;
identifying said patient's health-care plan on a local, remote, or web server; and
calculating an expected cost for said medical visit.
